(19) United States
(12) Patent Application Publication
(10) Pub. No.: US 2007/0238847 A1
(43) Pub. Date: Oct. 11, 2007

(54) METHOD FOR FORMING REACTIVE SILANE ESTERS

(75) Inventors: Jennifer A. Coggan, Cambridge (CA); Sarah J.P. Robinson, Mississauga (CA); Roger E. Gaynor, Oakville (CA); Timothy P. Bender, Toronto (CA); H. Bruce Goodbrand, Hamilton (CA)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/279,331

(22) Filed: Apr. 11, 2006

(51) Int. Cl. C08G 77/04; C08L 83/04

(52) U.S. Cl. 528/26; 528/42; 430/64

(57) ABSTRACT

Methods are provided for preparing reactive silane ester compounds, such as aromatic reactive silane ester compounds. The methods include providing a carboxylic acid-containing starting material, reacting the carboxylic acid-containing starting material with a base to form a salt, and reacting the salt with a halo-alkylene-silane to form a reactive silane ester compound. Compositions prepared by these methods, protective layers that include hydrolysis and condensation products of such compositions, electrophotographic photoreceptors that include such protective layers, and image forming apparatus that include such electrophotographic photoreceptors are also provided.

### TECHNICAL FIELD

This disclosure relates generally to improved chemical processes for the synthesis of reactive silane esters, and to the use of such reactive silane esters in producing overcoat layers for electrophotographic imaging members. The present disclosure relates specifically to efficient, scalable methods of making such reactive silane esters, electrophotographic photoreceptors, process cartridges, and image forming apparatuses.

### RELATED APPLICATIONS

Commonly assigned, U.S. patent application Ser. No. 10/709,193 filed Apr. 20, 2004, describes a process for preparing an aryl iodide compound, comprising: reacting an aryl halide compound with a metal iodide, a metal catalyst and a catalyst coordinating ligand in at least one solvent to form an aryl iodide; and purifying the aryl iodide; wherein the solvent is heated to reflux during the reacting; wherein an aryl iodide yield of at least about 75% is obtained; and wherein the aryl iodide has a purity of at least 90%.

Commonly assigned, U.S. patent application Ser. No. 10/938,887 filed Sep. 13, 2004, describes a silicon layer for electrophotographic photoreceptors comprising one or more siloxane-containing compound; and an antioxidant; wherein the antioxidant is at least one selected from the group consisting of hindered phenol antioxidants, hindered amine antioxidants, thioether antioxidants and phosphite antioxidants.

Commonly assigned, U.S. patent application Ser. No. 10/992,690 filed Nov. 22, 2004, describes a process for forming a tertiary arylamine compound, comprising reacting an arylbromide and an arylamine. For example, the application describes a process for forming N,N-diphenyl-4-aminobiphenyl, comprising reacting 4-bromobiphenyl and diphenylamine in the presence of a palladium-ligated catalyst.

Commonly assigned, U.S. patent application Ser. No. 10/992,687 filed Nov. 22, 2004, describes a process for forming a 4-aminobiphenyl derivative arylamine compound, comprising: (i) providing a first disubstituted 4-aminobiphenyl compound; (ii) optionally formylating the first disubstituted 4-aminobiphenyl compound to form a bisformyl substituted compound, where the first disubstituted 4-aminobiphenyl compound is not a bisformyl substituted compound; (iii) acidifying the bisformyl substituted compound to convert formyl functional groups into acid functional groups to form an acidified compound; and (iv) hydrogenating the acidified compound to saturate at least one unsaturated double bonds in the acidified compound, wherein there is provided a second disubstituted 4-aminobiphenyl compound.

Commonly assigned, U.S. patent application Ser. No. 10/992,658 filed Nov. 22, 2004, describes a process for forming a 4-aminobiphenyl derivative arylamine compound, comprising: (i) providing an iodinated organic compound; (ii) substituting the iodinated organic compound at carboxylic acid groups thereof to provide ester protecting groups; (iii) conducting an Ullman condensation reaction to convert the product of step (ii) into an arylamine compound; and (iv) conducting a Suzuki coupling reaction to add an additional phenyl group to the arylamine compound in the 4-position relative to the nitrogen, to provide the 4-aminobiphenyl derivative arylamine compound.

Commonly assigned, U.S. patent application Ser. No. 10/998,585 filed Nov. 30, 2004, describes a silicon-containing layer for electrophotographic photoreceptors comprising: one or more siloxane-containing compound; and one or more siloxane-containing antioxidant; wherein the siloxane-containing antioxidant is at least one member selected from the group consisting of hindered-phenol antioxidants, hindered-amine antioxidants, thioether antioxidants and phosphite antioxidants.

Commonly assigned, U.S. patent application Ser. No. 11/034,062 filed Jan. 13, 2005, describes an aromatic silicon-containing compound, having the formula (I): Ar—[X-L-SiRₙ(OR′)₃₋ₙ]ₘ (I) wherein: Ar represents an aromatic group; X represents a divalent or trivalent group; L represents a divalent linking group; K represents a hydrogen atom, an alkyl group or an aryl group; R′ represents an alkyl group having 1 to 5 carbon atoms; n is an integer of from 0 to 2; and m is an integer of from 1 to 5.

Commonly assigned, U.S. patent application Ser. No. 11/034,713 filed Jan. 14, 2005, describes an electrophotographic photoreceptor comprising a charge-generating layer, a charge-transport layer, and an overcoat layer comprised of a crosslinked siloxane composite composition comprising at least one siloxane-containing compound and metal oxide particles.

Commonly assigned, U.S. patent application Ser. No. 11,073,548 filed Mar. 8, 2005, describes an imaging member comprising: a substrate, a charge generating layer, a charge transport layer, and an external overcoating layer comprising an electron conductive material.

Commonly assigned, U.S. patent application Ser. No. 11/094,683 filed Mar. 31, 2005, describes a process for forming an anhydrous alkali earth salt of a dicarboxylic acid of an arylamine compound, comprising reacting a dicarboxylic acid of an arylamine compound with an anhydrous alkali earth salt. The application also discloses a process for forming a siloxane-containing hole-transport molecule, comprising: reacting a dicarboxylic acid of an arylamine compound with an anhydrous alkali earth salt to form an anhydrous dicarboxylic acid salt of the arylamine compound; and reacting the anhydrous dicarboxylic acid salt of the arylamine compound with a siloxane-containing compound.

Commonly assigned, U.S. patent application Ser. No. 11/234,275 filed Sep. 26, 2005, describes an electrophotographic imaging member comprising: a substrate, a charge generating layer, a charge transport layer, and an overcoating layer, said overcoating layer comprising a cured polyester polyol or cured acrylated polyol film forming resin and a charge transport material.

Commonly assigned, U.S. patent application Ser. No. 11/246,127 filed Oct. 1, 2005, describes a silicon-containing layer comprising sol-gel polymerization products of a mixture of siloxane precursor materials that comprises one or more siloxane-containing compounds, one or more disilanol compounds and one or more alcohols.

Commonly assigned, U.S. patent application Ser. No. 11/263,671 filed Nov. 1, 2005, describes a process for the preparation of a tertiary arylamine compound, comprising reacting an arylhalide and an arylamine in an ionic liquid in the presence of a catalyst.

Commonly assigned, U.S. patent application Ser. No. 11/267,336 filed Nov. 7, 2005, describes an interpenetrating network comprising an organic siloxane-containing material and a polymeric binder material.

Commonly assigned, U.S. patent application Ser. No. 11/795,134 filed Dec. 13, 2005, describes an electrophotographic imaging member comprising: a substrate, a charge generating layer, a charge transport layer, and an overcoating layer, said overcoating layer comprising a terphenyl arylamine dissolved or molecularly dispersed in a polymer binder.

Commonly assigned, U.S. patent application Ser. No. 11/004,388 filed Dec. 3, 2004, describes a method for forming silane esters, the method comprising reacting an anhydrous salt of a carboxylic acid with a silane in a two-phase reaction system, wherein the silane comprises a halo-alkyl substituent, and the two-phase reaction system comprises i) a first solvent, and ii) a second solvent that is substantially non-miscible in the first solvent.

The appropriate components and process aspects of each of the foregoing, such as the aromatic silicon-containing compounds and electrophotographic imaging members, may be selected for the present disclosure in embodiments thereof. The entire disclosures of the above-mentioned applications are totally incorporated herein by reference.

### REFERENCES

JP-A-63-65449 (the term “JP-A” as used herein means an “unexamined published Japanese patent application”), discloses an electrophotographic photoreceptor in which fine silicone particles are added to a photosensitive layer, and also discloses that such addition of the fine silicone particles imparts lubricity to a surface of the photoreceptor.

Further, in forming a photosensitive layer, a method has been proposed in which a charge transport substance is dispersed in a binder polymer or a polymer precursor thereof, and then the binder polymer or the polymer precursor thereof is cured. JP-B-5-47104 (the term “JP-B” as used herein means an “examined Japanese patent publication”) and JP-B-60-22347, disclose electrophotographic photoreceptors using silicone materials as the binder polymers or the polymer precursors thereof.

Furthermore, in order to improve mechanical strength of the electrophotographic photoreceptor, a protective layer is formed on the surface of the photosensitive layer in some cases. A cross-linkable resin is used as a material for the protective layer in many cases. However, the protective layer formed by the cross-linkable resin acts as an insulating layer, which impairs the photoelectric characteristics of the photoreceptor. For this reason, a method of dispersing a fine conductive metal oxide powder (JP-A-57-128344) or a charge-transport substance (JP-A-4-15659) in the protective layer and a method of reacting a charge-transport, substance having a reactive functional group with a thermoplastic resin to form the protective layer have been proposed.

However, even the above-mentioned conventional electrophotographic photoreceptors are not necessarily sufficient in electrophotographic characteristics and durability, particularly when used in combination with a charger of the contact-charging system (contact charger) or a cleaning apparatus, such as a cleaning blade.

Further, when a photoreceptor is used in combination with a contact charger and a toner obtained by chemical polymerization (polymerization toner), a surface of the photoreceptor may become stained with a discharge product produced in contact charging or with polymerization toner that remains after a transport step. This staining can deteriorate image quality in some cases. Still further, use of a cleaning blade to remove discharge product or remaining toner adhered to the photoreceptor surface increases friction and abrasion between the surface of the photoreceptor and the cleaning blade, resulting in a tendency to cause damage to the surface of the photoreceptor, breakage of the blade or turning up of the blade.

Furthermore, in producing a photoreceptor, in addition to improvement in electrophotographic characteristics and durability, reducing production costs becomes an important problem. However, conventional electrophotographic photoreceptors also may have problems relating to coating defects such as orange peel appearances and hard spots.

The use of silicon-containing compounds in photoreceptor layers, including in photosensitive and protective layers, has been shown to increase the mechanical lifetime of electrophotographic photoreceptors, under charging conditions and scorotron charging conditions. For example, U.S. Patent Application Publication US 2004/0086794 to Yamada et al. discloses a photoreceptor having improved mechanical strength and stain resistance.

However, the above-mentioned conventional electrophotographic photoreceptor is not necessarily sufficient in electrophotographic characteristics and durability, particularly when such a photoreceptor is used in an environment of high heat and humidity.

Photoreceptors having low wear rates, such as those described in Yamada, also have low refresh rates. The low wear and refresh rates are a primary cause of image-deletion errors, particularly under conditions of high humidity and high temperature. U.S. Pat. No. 6,730,448 B2 to Yoshino et al. addresses this issue, disclosing photoreceptors having some improvement in image quality, fixing ability, ever, in an environment of high heat and humidity. However, there still remains a need for electrophotographic photoreceptors having high mechanical strength and improved electrophotographic characteristics and improved image deletion characteristics even under conditions of high temperature and high humidity.

The disclosures of each of the foregoing patents and publications, and the disclosures of any patents and publications cited below, are hereby totally incorporated by reference. The appropriate components and process aspects of the each of the cited patents and publications may also be selected for the present compositions and processes in embodiments thereof.

### BACKGROUND

In electrophotography, an electrophotographic substrate containing a photoconductive insulating layer on a conductive layer is imaged by first uniformly electrostatically charging a surface of the substrate. The substrate is then exposed to a pattern of activating electromagnetic radiation, such as, for example, light. The light or other electromagnetic radiation selectively dissipates the charge in illuminated areas of the photoconductive insulating layer while leaving behind an electrostatic latent image in non-illuminated areas of the photoconductive insulating layer. This electrostatic latent image is then developed to form a visible image by depositing finely divided electroscopic marking particles on the surface of the photoconductive insulating layer. The resulting visible image is then transferred from the electrophotographic substrate to a necessary member, such as, for example, an intermediate transfer member or a print substrate, such as paper. This image-developing process can be repeated as many times as necessary with reusable photoconductive insulating layers.

Image forming apparatus such as copiers, printers and facsimiles, including electrophotographic systems for charging, exposure, development, transfer, etc., using electrophotographic photoreceptors have been widely employed. In such image-forming apparatus, there are ever-increasing demands for improving the speed of the image-forming processes, improving image quality, miniaturizing and prolonging the life of the apparatus, reducing production and running costs, etc. Further, with recent advances in computers and communication technology, digital systems and color-image output systems have been applied also to image-forming apparatus.

Electrophotographic imaging members (i.e. photoreceptors) are well known. Photoreceptors having either a flexible belt or a rigid drum configuration are commonly used in electrophotographic processes. Photoreceptors may comprise a photoconductive layer including a single layer or composite layers. These photoreceptors take many different forms. For example, layered photo-responsive imaging members are known in the art. U.S. Pat. No. 4,265,990 to Stolka et al., which is incorporated herein by reference in its entirety, describes a layered photoreceptor having separate photo-generating and charge-transport layers. The photo-generating layer disclosed in the 990 patent is capable of photo-generating holes and injecting the photo-generated holes into the charge-transport layer. Thus, in the photoreceptors of the 990 patent, the photo-generating material generates electrons and holes when subjected to light.

More advanced photoconductive photoreceptors containing highly specialized component layers are also known. For example, multilayered photoreceptors may include one or more of a substrate, an undercoating layer, an intermediate layer, an optional hole- or charge-blocking layer, a charge-generating layer (including a photo-generating material in a binder) over an undercoating layer and/or a blocking layer, and a charge-transport layer (including a charge-transport material in a binder). Additional layers, such as one or more overcoat layer or layers, may be included as well.

In view of such a background, improvement in electrophotographic properties and durability, miniaturization, reduction in cost, etc., in photoreceptors have been studied, and photoreceptors using various materials, including cross-linked siloxane materials, have been proposed.

However, there are shortcomings associated with current methods for producing reactive silane esters, such as for use in producing overcoat layers for electrophotographic imaging members. For example, current processes are generally lengthy, result in low product yields, and produce crude products containing variable amounts of impurities and oligomers, necessitating further tedious and non-scalable purification procedures.

Thus, there still remains a need for improved methods for preparing reactive silane esters that will produce high yields of the desired compounds, and there remains a need for efficient, scalable methods for preparing the reactive silane esters.

### SUMMARY

The present disclosure addresses these and other needs, by providing a one-pot, two-step method of preparing reactive silane esters from carboxylic acid compounds. The disclosed processes provide the desired reactive silane esters in a scaleable process and in high purity.

The process of embodiments differs from current processes by the use of a base, such as a solid base in the acid-base reaction rather than a liquid base. Use of a solid base rather than a liquid base, in particular, allows for such benefits as the solid base is much easier to handle in large quantities and, for some solid bases, no water is produced during the reaction such that water does not need to be removed during the course of the reaction such as by azeotropic distillation. Further, the crude reaction product is relatively pure, compared to previous conditions, which leads to shorter purification times. Also, the processes of the disclosure allow for increased reaction throughput. This produces an efficient, scaleable process that provides the desired product in high yield and in a faster process.

In embodiments, the disclosure provides a method for preparing reactive silane esters, comprising:

providing a carboxylic acid-containing starting material;

reacting said carboxylic acid-containing starting material with a base to form a salt; and

reacting said salt with a halo-alkylene-silane to form a reactive silane ester compound.

For example, in the disclosed process, the carboxylic acid-containing starting material can be an aromatic compound of the formula 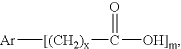
the halo-alkylene-silane can be of the formula Y-L-SiRₙ(OR)₃₋ₙ, and the resultant reactive silane ester compound can be of the formula 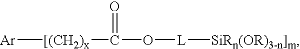
wherein:

Ar represents an aromatic group;

Y represents a halogen atom selected from the group consisting of I, Br, Cl and F;

L represents a divalent linking group;

each R independently represents a hydrogen atom, an alkyl group, or an aryl group;

n is an integer of from 0 to 2;

x is an integer of from 0 to about 25; and

m is an integer of from 1 to 5.

### BRIEF DESCRIPTION OF THE DRAWINGS

FIG. 1 is a schematic cross sectional view showing an embodiment of an electrophotographic photoreceptor of the disclosure.

FIG. 2 is a schematic view showing an embodiment of an image forming apparatus of the disclosure.

FIG. 3 is a schematic view showing another embodiment of an image forming apparatus of the disclosure.

### EMBODIMENTS

This disclosure is not limited to particular embodiments described herein, and some components and processes may be varied by one of skill, based on this disclosure. The terminology used herein is for the purpose of describing particular embodiments only, and is not intended to be limiting.

In this specification and the claims that follow, singular forms such as “a,” “an,” and “the” include plural forms unless the content clearly dictates otherwise. In addition, reference may be made to a number of terms that shall be defined as follows:

The term “organic molecule” refers, for example, to any molecule that is made up predominantly of carbon and hydrogen, such as, for example, alkanes and arylamines. The term “heteroatom” refers, for example, to any atom other than carbon and hydrogen. Typical heteroatoms included in organic molecules include oxygen, nitrogen, sulfur and the like.

The term “saturated” refers, for example, to compounds containing only single bonds. The term “unsaturated” refers, for example, to compounds that contain one or more double bonds and/or one or more triple bonds.

The terms “hydrocarbon” and “alkane” refer, for example, to branched and unbranched molecules having the general formula CₙH₂ₙ₊₂, in which n is a number of 1 or more, such as of from about 1 to about 60. Exemplary alkanes include methane, ethane, n-propane, isopropane, n-butane, isobutane, tert-butane, octane, decane, tetradecane, hexadecane, eicosane, tetracosane and the like. Alkanes may be substituted by replacing hydrogen atoms with one or more functional groups. The term “aliphatic” refers, for example, to straight-chain molecules, and may be used to describe acyclic, unbranched alkanes. The term “long-chain” refers, for example, to hydrocarbon chains in which n is a number of from about 8 to about 60, such as from about 20 to about 45 or from about 30 to about 40. The term “short-chain” refers, for example, to hydrocarbon chains in which n is a number of from about 1 to about 7, such as from about 2 to about 5 or from about 3 to about 4.

The term “alkyl” refers, for example, to a branched or unbranched saturated hydrocarbon group, derived from an alkane and having the general formula CₙH₂ₙ₊₁, in which n is a number of 1 or more, such as of from about 1 to about 60. Exemplary alkyl groups include methyl, ethyl, n-propyl, isopropyl, n-butyl, isobutyl, tert-butyl, octyl, decyl, tetradecyl, hexadecyl, eicosyl, tetracosyl and the like. The term “lower alkyl” refers, for example, to an alkyl group of from about 1 to about 12 carbon atoms.

The term “alkylene” refers, for example, to a branched or unbranched saturated hydrocarbon group of about 1 to about 12 carbon atoms and having two bonds to other portions of the molecule. Exemplary alkylene groups have the structure —(CH₂)ₐ—, in which a is an integer in a range of from about 1 to about 12.

The term “alkene” refers, for example, to branched and unbranched unsaturated molecules that are derived from alkenes and include one or more double bonds between carbon atoms. Exemplary alkanes include ethene, propene, butene, butadiene, octene, decene, tetradecene, hexadecene, eicosene, tetracosene and the like. Alkenes may be substituted by replacing hydrogen atoms with one or more functional groups.

The term “alkenyl” refers, for example, to a branched or unbranched unsaturated hydrocarbon group containing one or more double bond and derived from an alkene. Exemplary alkenyl groups include ethenyl, propenyl, butenyl, octenyl, decenyl, tetradecenyl, hexadecenyl, eicosenyl, tetracosenyl and the like. The term “lower alkenyl” refers, for example, to an alkenyl group of from about 1 to about 12 carbon atoms.

The term “alkyne” refers, for example, to branched and unbranched unsaturated molecules that are derived from alkanes and include one or more triple bonds between carbon atoms. Exemplary alkynes include ethyne, propyne, butyne, octyne, decyne, tetradecyne, hexadecyne, eicosyne, tetracosyne and the like. Alkynes may be substituted by replacing hydrogen atoms with one or more functional groups.

The term “alkynyl” refers, for example, to a branched or unbranched unsaturated hydrocarbon group containing one or more triple bond and derived from an alkyne. Exemplary alkynyl groups include ethynyl, propynyl, butynyl, octynyl, decynyl, tetradecynyl, hexadecynyl, eicosynyl, tetracosynyl and the like. The term “lower alkynyl” refers, for example, to an alkynyl group of from about 1 to about 12 carbon atoms.

The term “aromatic” refers, for example, to an organic molecule or radical in which some of the bonding electrons are delocalized or shared among several atoms within the molecule and not localized in the vicinity of the atoms involved in the bonding. Aromatic compounds may include heteroatoms in the molecules, and may include one or more cyclic or ring systems that may include one or more fused aromatic rings. Examples of aromatic compounds include, for example, benzene (C₆H₆), naphthalene (C₁₀H₈), anthracene (C₁₄H₁₀), pyridine (C₅H₅N) and the like. Optionally, these aromatic compounds may be substituted with one or more independently selected substituents, including alkyl, alkenyl, alkoxy, aryl, hydroxyl and nitro groups.

The term “aryl” refers, for example, to an organic group derived from an aromatic compound and having the same general structure as the aromatic compound. Examples of aromatic compounds include, for example, phenyl(C₆H₅), benzyl(C₇H₇), naphthyl(C₁₀H₇), anthracyl(C₁₄H₉), pyridinyl(C₅H₄N) and the like. Optionally, these aromatic groups may be substituted with one or more independently selected substituents, including alkyl, alkenyl, alkoxy, aryl, hydroxyl and nitro groups.

The term “arylamine” refers, for example, to moieties containing both aryl and amine groups. Exemplary aralkylene groups have the structure Ar—NRR′, in which Ar represents an aryl group and R and R′ are groups that may be independently selected from hydrogen and substituted and unsubstituted alkyl, alkenyl, aryl and other suitable functional groups. The term “triarylamine” refers, for example, to arylamine compounds having the general structure NArAr′Ar″, in which Ar, Ar′ and Ar″ represent independently selected aryl groups.

The term “alkoxy” refers, for example, to an alkyl group bound through a single, terminal ether linkage; that is, an “alkoxy” group is defined as —OR in which R is an alkyl as defined above. A “lower alkoxy” refers, for example, to an alkoxy group containing 1 to about 6 carbon atoms.

The term “aralkylene” refers, for example, to moieties containing both alkylene and monocyclic species, typically containing less than about 12 carbon atoms in the alkylene portion, and wherein the aryl substituent is bonded to the structure of interest through an alkylene linking group. Exemplary aralkylene groups have the structure —(CH₂)ₐ—Ar, in which Ar represents an aryl group and a is an integer in a range of from 1 to about 6.

The term “siloxane” refers, for example, to compounds containing silicon atoms bound to oxygen atoms and to organic groups. Exemplary siloxanes have the structure ROSiR′R″R′″, in which 0 represents oxygen, Si represents silicon and R, R′, R″ and R′″ represent independently selected organic groups, such as alkyl, alkenyl, alkynyl, alkoxy and other suitable groups.

“Alcohol” refers, for example, to an alkyl moiety in which one or more of the hydrogen atoms has been replaced by an —OH group. The term “lower alcohol” refers, for example, to an alkyl group of about 1 to about 6 carbon atoms in which at least one, and optionally all, of the hydrogen atoms has been replaced by an —OH group. The term “primary alcohol” refers, for example to alcohols in which the —OH group is bonded to a terminal or chain-ending carbon atom, such as in methanol, ethanol, 1-propanol, 1-butanol, 1-hexanol and the like. The term “secondary alcohol” refers, for example to alcohols in which the —OH group is bonded to a carbon atom that is bonded to one hydrogen atom and to two other carbon atoms, such as in 2-propanol (isopropanol), 2-butanol, 2-hexanol and the like. The term “tertiary alcohol” refers, for example to alcohols in which the —OH group is bonded to a carbon atom that is bonded to three other carbon atoms, such as in methylpropanol (tert-butanol) and the like.

The terms “halogen” or “halogen atom” refer, for example, to atoms of the elements fluorine (F), chlorine (Cl), bromine (Br), iodine (I) and astatine (At). The term “halo” refers, for example, to substitution of a halogen atom for a hydrogen atom in an organic compound. “Haloalkyl” refers, for example, to an alkyl moiety in which one or more of the hydrogen atoms has been replaced by a halogen atom. The term “lower haloalkyl” refers, for example, to an alkyl group of about 1 to about 6 carbon atoms in which at least one, and optionally all, of the hydrogen atoms has been replaced by a halogen atom. The term “perhalogenated” refers, for example, to a compound in which all of the hydrogen atoms have been replaced by halogen atoms, while the phrase “partially halogenated” refers, for example, to a compound in which less than all of the hydrogen atoms have been replaced by halogen atoms.

The term “derivative” refers, for example, to compounds that are derived from another compound and maintain the same general stricture as the compound from which they are derived. For example, saturated alcohols and saturated amines are derivatives of alkanes.

The term “room temperature” refers, for example, to temperatures in a range of from about 20° C. to about 25° C.

“Optional” or “optionally” refer, for example, to instances in which subsequently described circumstance may or may not occur, and include instances in which the circumstance occurs and instances in which the circumstance does not occur.

The terms “one or more” and “at least one” refer, for example, to instances in which one of the subsequently described circumstances occurs, and to instances in which more than one of the subsequently described circumstances occurs.

In embodiments, “soluble” refers, for example, to the specified material being substantially soluble in the respective solvent, although complete (100%) solubility is not necessarily required. Likewise, in embodiments, “insoluble” refers, for example, to the specified material being substantially insoluble in the respective solvent, although complete (100%) insolubility is not necessarily required.

Reactive silane ester materials can be used as precursor materials for silicone-based hard coats or overcoats in imaging members or photoreceptors used in xerographic or electrostatographic printers. An example of reactive silane ester suitable for use in forming a silicone hard coat in a photoreceptor is the reactive silane ester of Formula I:

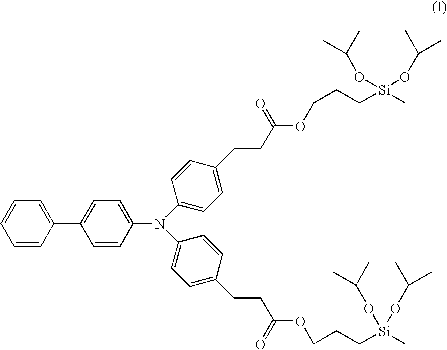

The silane ester of Formula I can be formed by forming a salt of a dicarboxylic acid of Formula I: 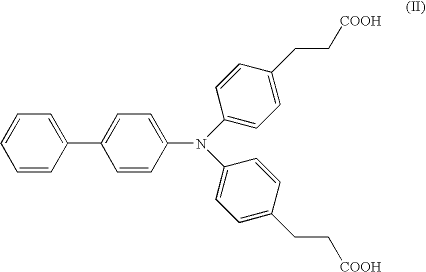
and then reacting the formed salt with an alkyl halide containing a siloxane group. The dicarboxylic acid of Formula I can be converted to a salt such as a dipotassium salt, by an acid-base reaction between the dicarboxylic acid and potassium t-butoxide in a solvent system such as a DMF-isopropanol mixture. A benefit of this reaction is that water is not produced by the reaction, and thus need not be removed by means such as azeotropic distillation. In a second step, which can be conducted in the same reactor vessel (or pot) the resulting salt, such as a resulting dipotassium salt, is reacted with a dialkoxy silane that includes a halogenated alkyl group, such as, for example, 3-iodopropyl methyl diisopropoxy silane. The dipotassium salt undergoes a condensation reaction with the silane to form a silane ester, such as, for example, the silane ester of Formula I.

A method is thus provided for preparing reactive silane esters by a one-pot two-step reaction, starting with the reaction of a carboxylic acid compound, such as an aromatic carboxylic acid starting compound, with a base in a solvent system to form a salt, followed by reacting the salt with a halo-alkylene-silane compound to provide the final product. For example, aromatic silicon-containing compound of the formula (I) above can be prepared by the following reaction: 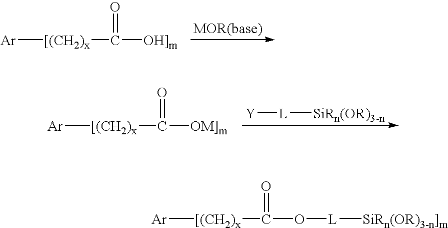
in which Ar represents any suitable aromatic group, such as an arylamine; Y represents a halogen atom selected from a group consisting of I, Br, Cl and F; L represents a divalent linking group, such as an alkyl group; each R independently represents a hydrogen atom, an alkyl group such as a lower alkyl group, or an aryl group; n is an integer of from 0 to 2; x is an integer of from 0 to about 25; and m is an integer of from 1 to 5. In the embodiments of an aromatic reactive silane ester formed by this method, the compound can generally be an aromatic silane compound, i.e., a compound having one or more silane groups separated by a liking group that is or contains one or more aromatic groups.

Examples of suitable starting materials generally include any materials that are substituted by one or more groups capable of forming divalent linkages by the described reaction. For example, suitable in embodiments as starting materials are substituted aromatic compounds in which one or more aryl groups (Ar) are substituted by one or more groups capable of forming divalent linkages such as carboxylic acid groups. Suitable substituted aromatic compounds thus include carboxylic acids, such as a dicarboxylic acid, where the carboxylic acid reacts in the acid-base reaction to form a salt, which is subsequently reacted to form the desired reactive silane ester. In particular embodiments, the starting material is an aromatic carboxylic acid, such as an arylamine carboxylic acid.

For example, the starting compound can be any suitable arylamine compound such as a compound of the formula: 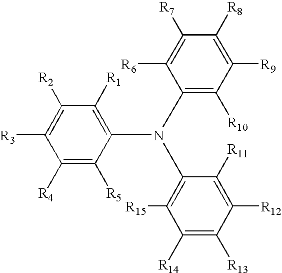
where R¹-R¹⁵ which can be the same or different, can be suitably selected to represent hydrogen, a halogen, an alkyl group having for example from 1 to about 20 carbon atoms, an aryl group optionally substituted by one or more alkyl groups, an alkyl group containing a heteroatom, an aryl group containing a heteroatom and optionally substituted by one or more alkyl groups, and the like, but where at least one of R¹-R¹⁵ is substituted by at least one carboxylic acid group or by at least one alkyl carboxylic acid group where the alkyl chain can be straight or branched, substituted or unsubstituted, and can have from 1 to about 20 or 30 or more carbon atoms. In embodiments, the arylamine is a diphenylamine derivative, such as a disubstituted 4-aminobiphenyl compound of the formula (II) above.

In the method of embodiments, the starting carboxylic acid compound is reacted with a base to form a salt. Any suitable base may be used in embodiments, such as an alkaline hydroxide or an alkaline alkoxide and the like. Exemplary bases that may be used in embodiments of the method include bases having the general formula MOR, in which O is oxygen, M is a metal atom, and R is a hydrogen or an alkyl group. I embodiments, M is a metal selected from potassium, sodium, lithium, calcium, magnesium and the like; and R is a hydrogen or a straight or branched alkyl group selected from methyl, ethyl, propyl, butyl, pentyl, hexyl, heptyl, octyl, nonyl, and decyl groups, such as methyl, ethyl, n-propyl, isopropyl, n-butyl, isobutyl, tert-butyl, octyl, decyl and the like. In embodiments, for example, the base may be a potassium tert-butoxide salt. In some embodiments, a solid base is used to provide improved handling and the like properties, although other bases can also be used.

In embodiments, the starting carboxylic acid material and the base may be reacted in any suitable amounts to provide the desired intermediate salt product. For example, the starting carboxylic acid material and the base may be provided in substantially equivalent amounts based on the number of carboxylic acid groups present in the starting material. Alternatively, the base may be provide in an amount greater than a carboxylic acid equivalent amount, to drive the reaction and ensure more complete conversion of carboxylic acid groups to salt groups.

The formation of salts in the method of embodiments may be carried out in any suitable solvent or mixture of solvents. Suitable solvents include, for example, alcohols, such as methanol, ethanol, isopropanol, butanol, and the like; other polar aprotic solvents such as dimethylformamide, dimethylsulfoxide, acetone, ethyl acetate, tetrahydrofuran, methyl ethyl ketone and the like; and mixtures thereof. In an embodiment, a solvent system of isopropanol and dimethylformamide can be used. The choice of specific solvent or mixture of solvents can be decided based on the solubility of the starting materials and products, and will be readily apparent or within routine experimentation to those skilled in the art. Solvents may also be chosen based on the desired operating temperature range.

In embodiments, the solvent may be included in amounts from about 75 to about 95% by weight, or from about 80 to about 90% by weight, based on the total weight of the reactants.

Salt formation in the method of embodiments nay be carried out at temperatures of from about 0° C. to about 100° C., such as from about 25° C. to about 85° C. or from about 50° C. to about 75° C. or about 70° C. For example, the reaction can be carried out at a temperature below the boiling point of the solvent used in the system. If desired, after the reaction is complete, the temperature can be raised to above the boiling point of the solvent to drive off or distill the solvent, to remove all of most of the solvent from the reactor vessel.

After the salt of the starting carboxylic acid compound is formed, the salt may be optionally isolated and/or purified. However, isolation and purification of the salt are not necessary to achieving high yields of final products with the method of embodiments. In fact, a benefit of embodiments is that the next step can be conducted in the same reactor vessel, or pot, as the first step, without isolation or purification of the products of the first step. Thus, the disclosure provides a one-pot, two-step process. Of course, if desired, the products of the first step can be suitably isolated or purified prior to conducting the second step of the process, and that second step can be conducted in the same or different reactor vessel.

After salt formation, one or more halo-alkylene-silane compounds are added to the reaction mixture. In embodiments, the halo-alkylene-silane compound has the general formula (III):
Y-L-SiRₙ(OR′)₃₋ₙ—. (III),
in which Y is a halogen atom; L represents a divalent linking group; each R is independently chosen from hydrogen atom, lower alkyl groups (such as alkyl groups having 1 to 12 carbon atoms) and aryl groups; and R′ is independently chosen from lower alkyl groups, such as alkyl groups having from 1 to 5 carbon atoms. Suitable examples of L include, but are not limited to: a divalent hydrocarbon group represented by —CₘH₂ₘ—, —CₘH₂ₘ₋₂—, —CₘH₂ₘ₋₄— (m is an integer of 1 to about 15, such as from 2 to about 10), —CH₂—C₆H₄— or —C₆H₄—C₆H₄—, or a divalent group in which two or more of them are combined. The divalent group may also optionally have a substituent group such as an alkyl group, a phenyl group, an alkoxyl group or an amino group on its side chain. In formula (III), n is an integer, which can be 0, 1 or 2, and m is an integer, which can be from 1 to 10, such as from 1 to 5. Such compounds may be used individually or in combinations of one or more such halo-alkylene-silane compounds. In embodiments, exemplary halo-alkyene-silane compounds include, for example, fluoropropylmethyldiisopropoxysilane, chloropropylmethyldiisopropoxysilane, bromopropylmethyldiisopropoxysilane and iodopropylmethylduisopropoxysilane, and mixtures thereof.

The silylalkylation reaction of embodiments may be carried out in any suitable solvent or mixture of solvents. Suitable solvents include any polar aprotic solvent, for example, dimethylformamide, or the solvents discussed above for use in the formation of the salt of the substituted aromatic compounds, as well as mixtures of such solvents with additional solvents including alcohols, such as methanol, ethanol, isopropanol and the like; and mixtures thereof. The choice of specific solvent or mixture of solvents can be decided based on the solubility of the starting materials, intermediates and final products, and will be readily apparent or within routine experimentation to those skilled in the art. Solvents may be chosen based on the desired operating temperature range.

Reaction of the salt of the starting carboxylic acid compound with the halo-alkylene-silane compound in the method of embodiments may be carried out at temperatures of from about 25° C. to about 200° C., such as from about 50° C. to about 150° C. or from about 80° C. to about 110° C., such as about 90° C. In embodiments, the reaction of the salt of the starting carboxylic acid compound with the halo-alkylene-silane may be conducted at a temperature that is about 5° C. to about 30° C. greater than the temperature at which the salt is formed. The reaction may be carried out for about 1 min to about 5 hours, such as from about 30 min to about 2 hours.

After the reaction, the product can be isolated by any suitable method or combination of methods, such as solvent extraction. The final product can be purified by any process known in the art, such as distillation, recrystallization, and flash column chromatography.

If purification of the product is desired, then a particularly suitable method of column chromatography can be used to quickly purify the product while still providing a high product yield. For example, the desired final product can be extracted from the reaction mixture using cyclohexane, and the cyclohexane extract/reactive silane ester mixture applied directly into the silica gel chromatography column. Thus, for example, cyclohexane can be added to the reaction product mixture, stirred, and the various resulting phases separated by, for example, a separatory funnel, and optionally washed and dried.

Where column chromatography is used for purification, the proportion of crude cyclohexane extract reactive silane ester to silica gel in the column can be any suitable amount, although a crude extract mixture to silica gel ratio of from about 1:30 to about 1:3, such as about 1:20 to about 1:5 or about 1:15 to about 1:7 such as about 1:10, in terms of equivalents, can be used. The desired reactive silane ester product can be eluted from the column by any suitable materials, such as a 10% ethyl acetate/cyclohexane mixture. The product can be further collected and concentrated, such as under a reduced pressure, and volatile materials can be removed such as by a Kugelrohr distillation, if desired.

The reactive silane ester compounds produced by this process can be used as final products, for example as aromatic binder materials or as a charge-transport material in electrostatographic imaging members. Alternatively, the reactive silane ester compounds can be further processed and/or reacted to provide other compounds for their separate use. For example, the aromatic silicon-containing compound of formula (I) may be produced by the method of embodiments, hydrolyzed and condensed to form a cross-linked siloxane-containing component, which can be incorporated into a silicon hard overcoat layer of a electrophotographic photoreceptor. The product of hydrolysis and condensation of the aromatic silicon-containing compound can be present in an amount of about 5% to about 80% of the total weight of cross-linked siloxane-containing outmost protective layer. The product of hydrolysis and condensation of the aromatic silicon-containing compound, such as the aromatic silicon-containing compound of formula (I), is present in an amount of about 20% to about 60% of the total weight of the silicon hard overcoat layer. An exemplary electrostatographic imaging member will now be described in greater detail.

In electrophotographic photoreceptors of embodiments, the photoreceptors can include various layers such as undercoating layers, charge-generating layers, charge-transport layers, overcoat layers, and the like. The overcoating layers of embodiments can be a silicon-overcoat layer, which can comprise one or more silicon compounds, a resin, and a charge-transport molecule such as an arylamine.

In embodiments, the resin may be a resin soluble in a liquid component in a coating solution used for formation of a silicon-overcoat layer. Such a resin soluble in the liquid component may be selected based upon the kind of liquid component. For example, if the coating solution contains an alcoholic solvent, a polyvinyl acetal resin such as a polyvinyl butyral resin, a polyvinyl formal resin or a partially acetalized polyvinyl acetal resin in which butyral is partially modified with formal or acetoacetal, a polyamide resin, a cellulose resin such as ethyl cellulose and a phenol resin may be suitably chosen as the alcohol-soluble resins. These resins may be used either alone or as a combination of two or more resins. Of the above-mentioned resins, the polyvinyl acetal resin is particularly suitable in embodiments in terms of electric characteristics.

In embodiments, the weight-average molecular weight of the resin soluble in the liquid component may be from about 2,000 to about 1,000,000, such as from about 5,000 to about 50,000. When the weight-average molecular weight is less than about 2,000, enhancing discharge-gas resistance, mechanical strength, scratch resistance, particle dispersibility, etc., tend to become insufficient. However, when the weight-average molecular weight exceeds about 1,000,000, the resin solubility in the coating solution decreases, and the amount of resin added to the coating solution may be limited and poor film formation in the production of the photosensitive layer may result.

Further, the amount of the resin soluble in the liquid component may be, in embodiments, from about 0.1 to about 115% by weight, or from about 0.5 to about 110% by weight, based on the total amount of the coating solution. When the amount added is less than 0.1% by weight, enhancing discharge-gas resistance, mechanical strength, scratch resistance, particle dispersibility, etc. tend to become insufficient. However, if the amount of the resin soluble in the liquid component exceeds about 15% by weight, there is a tendency for formation of indistinct images when the electrophotographic photoreceptor of the disclosure is used at high temperature and high humidity.

There is no particular limitation on the silicon compound used in embodiments of the disclosure, as long as it has at least one silicon atom. However, a compound having two or more silicon atoms in its molecule may be used in embodiments. The use of the compound having two or more silicon atoms in its molecule allows both the strength and image quality of the electrophotographic photoreceptor to be achieved at higher levels.

Further, in embodiments, the silicon compounds may include silane coupling agents such as a tetrafunctional alkoxysilane, such as tetramethoxysilane, tetraethoxysilane and the like; a trifunctional alkoxysilane such as methyltrimethoxysilane, methyltriethoxysilane, ethyltrimethoxysilane, methyltrimethoxyethoxysilane, vinyltrimethoxysilane, vinyltriethoxysilane, phenyltrimethoxysilane, γ-glycidoxypropylmethyldiethoxysilane, γ-glycidoxypropyltrimethoxysilane, γ-glycidoxypropyl-triethoxysilane, γ-aminopropyltriethoxysilane, γ-aminopropyltrimethoxysilane, γ-aminopropylmethyldimethoxysilane, N-β-(aminoethyl)-γ-aminopropyltriethoxysilane, (tridecafluoro-1,1,2,2-tetrahydrooctyl)triethoxysilane, (3,3,3-trifluoropropyl)-trimethoxysilane, 3-(heptafluoroisopropoxy)propyltriethoxysilane, 1H,1H,2H,2H-perfluoroalkyltriethoxysilane, 1H,1H,2H,2H-perfluorodecyltriethoxysilane or 1H,1H,2H,2H-perfluorooctyltriethoxysilane; a bifunctional alkoxysilane such as dimethyldimethoxysilane, diphenyldimethoxysilane or methylphenyldimethoxysilane; and a monofunctional alkoxysilane such as trimethylmethoxysilane. In order to improve the strength of the photosensitive layer, trifunctional alkoxysilanes and tetrafunctional alkoxysilanes may be used in embodiments, and in order to improve the flexibility and film-forming properties, monofunctional alkoxysilanes and bifunctional alkoxysilanes may be used in embodiments.

Silicone hard-coating agents containing these coupling agents can also be used in embodiments. Commercially available hard-coating agents include KP-85, X-40-9740 and X-40-2239 (available from Shinetsu Silicone Co., Ltd.), and AY42-440, AY42-441 and AY49-208 (available from Toray Dow Corning Co., Ltd.).

Various fine particles can also be added to the silicon compound containing layer, for example, to further improve the stain adhesion resistance and lubricity of embodiments of the electrophotographic photoreceptor. The fine particles may be used either alone or as a combination of two or more such fine particles. Non-limiting examples of the fine particles include fine particles containing silicon, such as fine particles containing silicon as a constituent element, and specifically include colloidal silica and fine silicone particles. The content of the fine silicone particles in the silicon-containing layer of embodiments may be within the range of 0.1 to 20% by weight, or within the range of 0.5 to 10% by weight, based on the total solid content of the silicon-containing layer.

Colloidal silica used in embodiments as the fine particles containing silicon in the disclosure is selected from an acidic or alkaline aqueous dispersion of the fine particles having an average particle size of 1 to 100 nm or 10 to 30 nm, and a dispersion of the fine particles in an organic solvent, such as an alcohol, a ketone or an ester, and generally, commercially available particles can be used.

There is no particular limitation on the solid content of colloidal silica in a top-surface layer of the electrophotographic photoreceptor of embodiments. However, in embodiments, colloidal silica may be included in amounts of from about 1 to about 50% by weight, such as from about 5 to about 30% by weight, based on the total solid content of the top surface layer, in terms of film forming properties, electric characteristics and strength.

The fine silicone particles used as the fine particles containing silicon in the disclosure may be selected from silicone resin particles, silicone rubber particles and silica particles surface-treated with silicone, which are spherical and have an average particle size of from about 1 to 500 nm, such as from about 10 to about 100 nm, and generally, commercially available particles can be used in embodiments.

In embodiments, the fine silicone particles are small-sized particles that are chemically inactive and excellent in dispersibility in a resin, and further are low in content as may be necessary for obtaining sufficient characteristics. Accordingly, the surface properties of the electrophotographic photoreceptor can be improved without inhibition of the cross-linking reaction. That is to say, fine silicone particles improve the lubricity and water repellency electrophotographic photoreceptor surfaces where incorporated into strong cross-linked structures, which may then be able to maintain good wear resistance and stain-adhesion resistance for a long period of time. The content of the fine silicone particles in the silicon compound-containing layer of embodiments may be from about 0.1 to about 20% by weight, such as from about 0.5 to about 10% by weight, based on the total solid content of the silicon compound-containing layer.

Other fine particles that may be used in embodiments include fine fluorine-based particles such as ethylene tetrafluoride, ethylene trifluoride, propylene hexafluoride, vinyl fluoride and vinylidene fluoride, and semiconductive metal oxides such as ZnO—Al₂O₃, SnO₂—Sb₂O₃, In₂O₃—SnO₂, ZnO—TiO₂, MgO—Al₂O₃, FeO—TiO₂, TiO₂, SnO₂, In₂O₃, ZnO and MgO.

In conventional electrophotographic photoreceptors, when the above-mentioned fine particles are contained in the photosensitive layer, the compatibility of the fine particles with a charge-transport substance or a binding resin may become insufficient, which causes layer separation in the photosensitive layer, and thus the formation of an opaque film. As a result, the electric characteristics have deteriorated in some cases. In contrast, the silicon compound-containing layer of embodiments (a charge-transport layer in this case) may contain the resin soluble in the liquid component in the coating solution used for formation of this layer and the silicon compound, thereby improving the dispersibility of the fine particles in the silicon compound-containing layer. Accordingly, the pot life of the coating solution may be sufficiently prolonged, and deterioration of the electric characteristics may be prevented.

Further, an additive such as a plasticizer, a surface modifier, an antioxidant, or an agent for preventing deterioration by light can also be used in the silicon compound-containing layer of embodiments. Non-limiting examples of plasticizers that may be used in embodiments include, for example, biphenyl, biphenyl chloride, terphenyl, dibutyl phthalate, diethylene glycol phthalate, dioctyl phthalate, triphenylphosphoric acid, methylnaphthalene, benzophenone, chlorinated paraffin, polypropylene, polystyrene and various fluorohydrocarbons.

The antioxidants may include an antioxidant having a hindered-phenol, hindered-amine, thioether or phosphite partial structure. This is effective for improvement of potential stability and image quality in environmental variation. The antioxidants include an antioxidant having a hindered-phenol, hindered-amine, thioether or phosphite partial structure. This is effective for improvement of potential stability and image quality in environ mental variation. For example, the hindered-phenol antioxidants include SUMILIZER BHT-R, SUMILIZER MDP-S, SUMILIZER BBM-S, SUMILIZER WX-R, SUMILIZER NW, SUMILIZER BP-76, SUMILIZER BP-101, SUMILIZER GA-80, SUMILIZER GM and SUMILIZER GS (the above are manufactured by Sumitomo Chemical Co., Ltd.), IRGANOX 1010, IRGANOX 1035, IRGANOX 1076, IRGANOX 1098, IRGANOX 1135, IRGANOX 1141, IRGANOX 1222, IRGANOX 1330, IRGANOX 1425WLj, IRGANOX 1520Lj, IRGANOX 245, IRGANOX 259, IRGANOX 3114, IRGANOX 3790, IRGANOX 5057 and IRGANOX 565 (the above are manufactured by Ciba Specialty Chemicals), and ADECASTAB AO-20, ADECASTAB AO-30, ADECASTAB AO-40, ADECASTAB AO-50, ADECASTAB AO-60, ADECASTAB AO-70, ADECASTAB AO-80 and ADECASTAB AO-3301 (the above are manufactured by Asahi Denka Co., Ltd.). The hindered-amine antioxidants include SANOL LS2626, SANOL LS765, SANOL LS770, SANOL LS744, TINUVIN 144, TINUVIN 622LD, MARK LA57, MARK LA67, MARK LA62, MARK LA68, MARK LA63 and SUMILIZER TPS, and the phosphite antioxidants include MARK 2112, MARK PEP•8, MARK PEP•24G, MARK PEP•36, MARK 329K and MARK HP•10. Of these, hindered-phenol and hindered-amine antioxidants may be particularly suitable, in embodiments.

There is no particular limitation on the thickness of the silicon-containing layer, however, in embodiments, the silicon-containing layer may be from about 2 to about 5 μm in thickness, such as from about 2.7 to about 3.2 μm in thickness.

The electrophotographic photoreceptor of embodiments may be either a function-separation-type photoreceptor, in which a layer containing a charge-generation substance (charge-generation layer) and a layer containing a charge-transport substance (charge-transport layer) are separately provided, or a monolayer-type photoreceptor, in which both the charge-generation layer and the charge-transport layer are contained in the same layer, as long as the electrophotographic photoreceptor of the particular embodiment has the photosensitive layer provided with the above-mentioned silicon compound-containing layer. The electrophotographic photoreceptor will be described in greater detail below, taking the function-separation-type photoreceptor as an example.

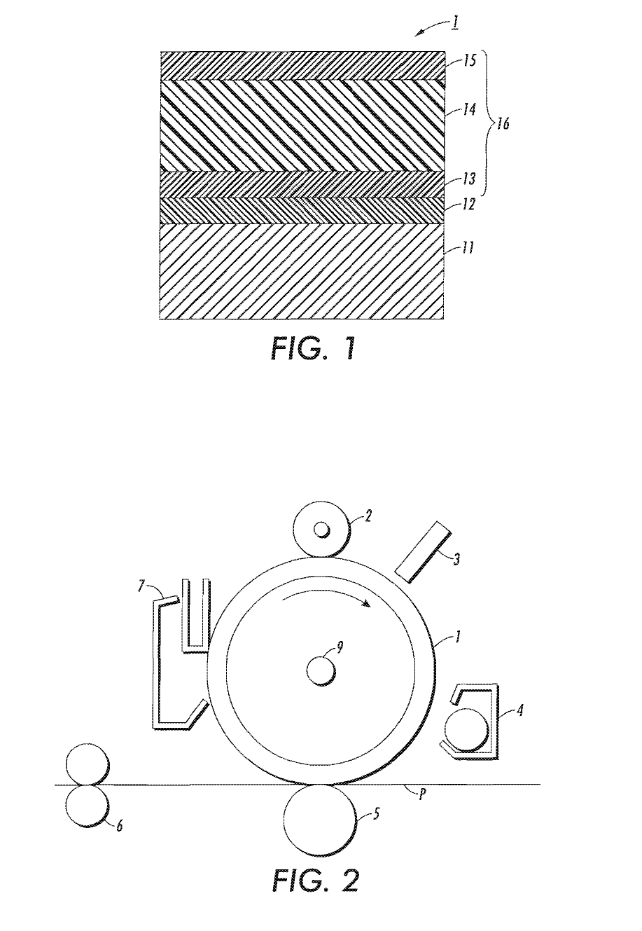

FIG. 1 is a cross-sectional view schematically showing an embodiment of the electrophotographic photoreceptor of the disclosure. The electrophotographic photoreceptor 1 shown in FIG. 1 is a function-separation-type photoreceptor in which a charge-generation layer 13 and a charge-transport layer 14 are separately provided. That is, an underlayer 12, the charge-generation layer 13, the charge transport layer 14 and a protective layer 15 are laminated onto a conductive support 11 to form a photosensitive layer 16. The protective layer 15 contains a resin soluble in the liquid component contained in the coating solution used for formation of this layer and the silicon compound. The various layers of the photoreceptor shown in FIG. 1 are generally known, and are described in detail in the above-mentioned commonly owned ad co-pending applications.

The electrophotographic photoreceptor of embodiments should not be construed as being limited to the above-mentioned constitution. For example, the electrophotographic photoreceptor shown in FIG. 1 is provided with the protective layer 15. However, when the charge transport layer 14 contains the resin soluble in the liquid component in the coating solution used for formation of this layer and the silicon compound, the charge transport layer 14 may be used as a top surface layer (a layer on the Side farthest apart from the support 11) without using the protective layer 15. In this case, the charge-transport substance contained in the charge transport layer 14 is desirably soluble in t liquid component in the coating solution used for formation of the charge-transport lay 14. For example, when the coating solution used for formation of the charge-transport layer 14 contains an alcohol solvent, the silicon compounds described above, including arylamine derivatives prepared by processes that include selective hydrogenation by catalytic transfer, can be used as the charge-transport substances. In embodiments, a particularly suitable charge-transport molecule is the following arylamine, which may be produced from the arylamines described herein.

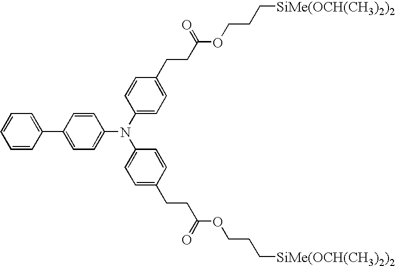

FIG. 2 is a schematic view showing an embodiment of an image forming apparatus or xerographic machine. In the apparatus shown in FIG. 2, an electrophotographic photoreceptor 1 is supported by a support 9, and rotatable at a specified rotational speed in the direction indicated by the arrow, centered on the support 9. A charging device 2, an exposure device 3, a developing device 4, a transfer device 5 and a cleaning unit 7 are arranged in this order along the rotational direction of the electrophotographic photoreceptor 1. Further, this exemplary apparatus is equipped with an image fixing device 6, and a medium P to which a toner image is to be transferred is conveyed to the image fixing device 6 through the transfer device 5.

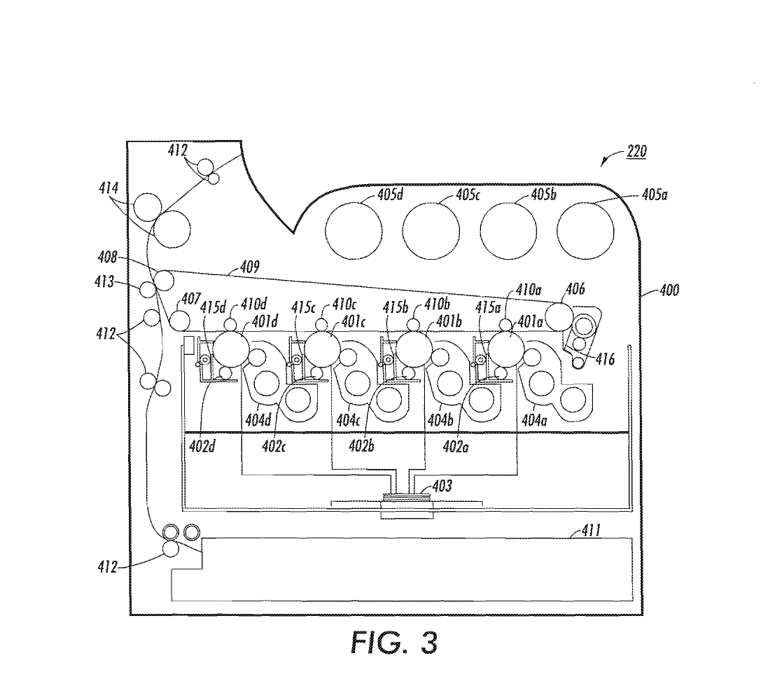

FIG. 3 is a cross-sectional view showing another exemplary embodiment of an image-forming apparatus. The image-forming apparatus 220 shown in FIG. 3 is an image-forming apparatus of an intermediate-transfer system, and four electrophotographic photoreceptors 401a to 401d are arranged in parallel with each other along an intermediate-transfer belt 409 in a housing 400.

Here, the electrophotographic photoreceptors 401a to 401d carried by the image-forming apparatus 220 are each the electrophotographic photoreceptors. Each of the electrophotographic photoreceptors 401a to 401d may rotate in a predetermined direction (counterclockwise on the sheet of FIG. 3), and charging rolls 402a to 402d, developing device 404a to 404d, primary transfer rolls 410a to 4110d and cleaning blades 415a to 415d are each arranged along the rotational direction thereof. In each of the developing device 404a to 404d, four-color toners of yellow (Y), magenta (M), cyan (C) and black (B) contained in toner cartridges 405a to 405d can be supplied, and the primary transfer rolls 410.a to 410d are each brought into abutting contact with the electrophotographic photoreceptors 401a to 401d through an intermediate-transfer belt 409.

Further, a laser-light source (exposure unit) 403 is arranged at a specified position in the housing 400, and it is possible to irradiate surfaces of the electrophotographic photoreceptors 401a to 401d after charging with laser light emitted from the laser-light source 403. This performs the respective steps of charging, exposure, development, primary transfer and cleaning in turn in the rotation step of the electrophotographic photoreceptors 401a to 401d, and toner images of the respective colors are transferred onto the intermediate-transfer belt 409, one over the other.

The intermediate-transfer belt 409 is supported with a driving roll 406, a backup roll 408 and a tension roll 407 at a specified tension, and rotatable by the rotation of these rolls without the occurrence of deflection. Further, a secondary transfer roll 413 is arranged so that it is brought into abutting contact with the backup roll 408 through the intermediate-transfer belt 409. The intermediate-transfer belt 409, which has passed between the backup roll 408 and the secondary transfer roll 413, is cleaned up by a cleaning blade 416, and then repeatedly subjected to the subsequent image-formation process.

Further, a tray (tray for a medium to which a toner image is to be transferred) 411 is provided at a specified position in the housing 400. The medium to which the toner image is to be transferred (such as paper) in the tray 411 is conveyed in turn between the intermediate-transfer belt 409 and the secondary transfer roll 413, and further between two fixing rolls 414 brought into abutting contact with each other, with a conveying roll 412, and then delivered out of the housing 400.

According to the exemplary image-forming apparatus 220 shown in FIG. 3, the use of electrophotographic photoreceptors of embodiments as electrophotographic photoreceptors 401a to 401d may achieve discharge gas resistance, mechanical strength, scratch resistance, etc. on a sufficiently high level in the image-formation process of each of the electrophotographic photoreceptors 401a to 401d. Accordingly, even when the photoreceptors are used together with the contact-charging devices or the cleaning blades, or further with the spherical toner obtained by chemical polymerization, good image quality can be obtained without the occurrence of image defects such as fogging. Therefore, also according to the image-forming apparatus for color-image formation using the intermediate-transfer body, such as this embodiment, the image-forming apparatus, which can stably provide good image quality for a long period of time, is realized.

The disclosure should not be construed as being limited to the above-mentioned embodiments. For example, each apparatus shown in FIG. 2 or 3 may be equipped with a process cartridge comprising the electrophotographic photoreceptor 1 (or the electrophotographic photoreceptors 401a to 401d) and charging device 2 (or the charging devices 402a to 402d). The use of such a process cartridge allows maintenance to be performed more simply and easily.

Further, in embodiments, when a charging device of the non-contact charging system such as a corotron charger is used in place of the contact-charging device 2 (or the contact-charging devices 402a to 402d), sufficiently good image quality can be obtained.

Specific examples are described in detail below. These examples are intended to be illustrative, and the materials, conditions, and process parameters set forth in these exemplary embodiments are not limiting. All parts and percentages are by weight unless otherwise indicated.

### EXAMPLES

### Example 1

To a 3 L 3-necked flask was fitted an argon inlet, mechanical stirrer and thermometer. The flask was charged with 1.1 L of isopropanol, 360 mL of DMF and 95 g of potassium t-butoxide, which was stirred at room temperature until complete dissolution. To this was added 187.2 g of N,N-di(4-propanoic acid)-4-aminobiphenyl (the compound of formula (II)) and the temperature was raised to 70° C. and stirred for 1 hour until the solution has produced a thick white precipitate. A further 730 ml of DMF was added. The reaction was set up for distillation and the temperature was raised for distillation of the isopropanol (b.p. 82° C.) to occur rapidly. Approximately 600 mL of isopropanol was removed by distillation. The temperature was set at 90° C. and 279 g of 3-iodopropyl methyl diisopropoxy silane was added. The reaction was stirred at 90° C. for 1.5 hours after which time the reaction was cooled to room temperature. To the room temperature reaction was added 1.2 L of cyclohexane and 100 mL of water. This mixture was stirred for a few minutes and then the reaction mixture was poured into a separatory funnel and the DIMF layer was removed. The cyclohexane layer washed with 1 L of a 50% brine solution. The organic layer was removed, dried (MgSO₄) and the MgSO₄ removed by filtration. The crude material was purified by column chromatography with 10 equivalents of silica gel, the material was added directly to the column in the cyclohexane extract and the material eluted with a 10% ethyl acetate/cyclohexane mixture. The appropriate fractions were collected and concentrated under reduced pressure to give 280 g (80% yield) of a yellow oil. Volatile materials were removed by Kugelrohr distillation at 180° C. for 2 hours to give 265 g (77% yield) of a yellow oil.

### Examples 2-9

Batches of the product of Example 1 were subjected to various purification processes. En particular, batches of the product were subjected to purification as follows:

| | Purifi- | | Crude | |
|---|---|---|---|---|
| Exam- | cation | SiO₂:Crude | extract | Elution |
| ple | method | ratio | solvent | solvents |
| 2 | Filtration | 5:1 | cyclohexane | 10% ethyl |
| | method | | | acetate/ |
| | | | | cyclohexane |
| 3 | Filtration | 5:1 | Cyclohexane | 10% ethyl |
| | method | | | acetate/ |
| | | | | cyclohexane |
| 4 | Column | 5:1 | Cyclohexane | 10% ethyl |
| | method | | | acetate/ |
| | | | | cyclohexane |
| 5 | Column | 10:1 | Cyclohexane | 10% ethyl |
| | method | | | acetate/ |
| | | | | cyclohexane |
| 6 | Column | 5:1 | Cyclohexane | 5% ethyl |
| | method | | | acetate/toluene |
| 7 | Column | 10:1 | Toluene | 5% ethyl |
| | method | | | acetate/toluene |
| 8 | Column | 10:1 | Toluene | 5% ethyl |
| | method | | | acetate/toluene |
| 9 | Column | 10:1 | Toluene | 5% ethyl |
| | method | | | acetate/toluene |

The product yield, purity of desired product, and percent presence of undesired oligomers were measured both as obtained from the production method, and after the purification methods. Purity of desired product was measured by HPLC, and percent presence of undesired oligomers was measured by GPC. The results are shown in the following Table, as compared to a control sample obtained from a current production and purification process.

| | Chemical Analysis, | | | Chemical Analysis, | | |
|---|---|---|---|---|---|---|
| | as produced | | | as purified | | |
| | Yield | Product | Oligomer | Yield | Product | Oligomer |
| Example | (%) | (%) | (%) | (%) | (%) | (%) |
| 2 | N/I | 93.33 | 2.47 | 81 | 98.75 | 1.65 |
| 3 | N/I | 92.12 | 1.27 | 79 | 99.59 | 0.93 |
| 4 | N/I | 92.78 | 1.89 | 72 | 98.90 | 1.19 |
| 5 | 95 | 92.86 | 6.46 | 79 | 100.0 | 0.0 |
| 6 | 95 | 92.86 | 2.31 | 64 | 100.0 | 0.71 |
| 7 | 95 | 92.86 | 2.31 | 75 | 99.14 | 0.0 |
| 8 | 93 | 91.66 | 3.06 | 72 | 99.71 | 0.0 |
| 9 | 91 | 92.52 | 2.80 | 76 | 100.0 | 0.0 |
| Control | N/A | N/A | N/A | N/A | 99.34 | 0.0 |

Notes:
N/I = not isolated
N/A = not available

### Example 10

Large scale synthesis of aromatic silicon-containing compound.

A 50 gallon reactor is charged with 10 kg DMF and then 36 kg of isopropanol and 4 kg of potassium t-butoxide are added under agitation and nitrogen. The reactor is then charged with 7.5 kg of N,N-di(4-propanoic acid)-4-aminobiphenyl (the compound of formula (II)) and the reactor temperature is increased to 70° C., and held at that temperature for 2 hours. Approximately 90 minutes later, 28 kg of DMF is added to the reactor and the temperature is increased to 100° C. and the EPA distillation begun. Once approximately 20 kg of IPA has been removed, the reactor is cooled to 80° C. 11.72 kg of 3-iodopropyl methyl diisopropoxy silane is then added to the reactor. The reactor jacket temperature is then increased to 90° C. and the reaction is to continue at 90° C. for 1.5-2 hours. When the reaction is complete, full cooling is applied and the batch is cooled to room temperature. Once the temperature is reduced to 25° C., 36 kg of cyclohexane is added to the reactor and agitation is continued for 30 minutes. The slurry is then passed through a bag filter apparatus and the reactor and bag filters are rinsed with 10 kg of cyclohexane. 5 kg of water is added and the layers are allowed to separate. The bottom layer is removed and then 40 kg of brine solution (10 kg NaCl in 30 kg water) is added. The bottom layer is again removed and then the reactor is then charged with 6 kg of magnesium sulphate. The slurry is then passed through a bag filter apparatus and the final product solution is collected. The reactor and bag filters are rinsed through with 10 kg of cyclohexane. The final product solution is applied onto a silica gel column in cyclohexane and the product eluted with a mixture of 10% ethyl acetate and cyclohexane. The fractions from the column containing the pure product are pumped into a reactor where the volatiles are removed by vacuum distillation. The yield was 11.1 kg (79%). The desired structure of the product was confirmed by ¹H NMR spectroscopy, high performance liquid chromatography and gel permeation chromatography.

The results of these Examples demonstrate that the process of Example 1 can be used to readily and scaleably produce the desired reactive silane ester in high yield, which can subsequently readily be purified by directly introducing the crude product into the silica gel column while it was still in the cyclohexane extract.

### Examples 1-18

The purified products of Examples 2-9 were formulated into overcoating layer formulations. The reactive silane esters were generally formulated into coating compositions as follows:

2.75 parts of the reactive silane ester, 1.5 parts of binder material of the formula: 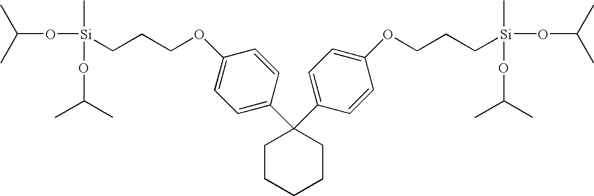
and 2.75 parts methanol were mixed, and 0.275 parts of an ion exchange resin (AMBERLIST H15) was added thereto, followed by stirring for 2 hours. Furthermore, 8 parts of butanol and 1.23 parts distilled water were added to this mixture, followed by stirring at room temperature for 20 minutes for polymerization to proceed. Then, the resulting mixture was filtered to remove the ion exchange resin, and 0.045 parts of aluminum trisacetylacetonate (Al(AcAc)₃), 0.045 parts of acetylacetone (AcAc), 0.5 parts of a polyvinyl butyral resin, 0.045 parts of butylated-hydroxytoluene (BHT) and 0.065 parts of a hindered phenol antioxidant (IRGANOX 259) were added to a filtrate obtained, and thoroughly dissolved therein for 3 hours and shaken overnight to obtain a clear coating solution for a protective layer. This coating solution was applied onto a charge transfer layer by dip coating (coating speed: about 170 mm/min), and dried by heating at 130° C. for one hour to form the protective layer having a film thickness of 3 μm, thereby obtaining a desired electrophotographic photoreceptor.

An example of the results from two photoreceptor drums plus one control drum that were coated show that the obtained thicknesses were within the standard thickness range for proper photoreceptor function. HMT cycling of the photoreceptors showed that the photoreceptors behaved as expected, having stable cycling behavior to 170 kcycles. The results are presented in the following table:

| | | | | | HMT @ |
|---|---|---|---|---|---|
| | Sample | | Coating | Potlife at | 140K cycle |
| Example | Example | Qualified | quality | 40° C. | (ΔVlow) |
| 11 | 2 | Yes | Pass | Pass | 7 |
| 12 | 3 | Yes | Pass | Pass | 28 |
| 13 | 4 | Yes | Pass | Pass | 18 |
| 14 | 5 | Yes | Pass | Pass | −4 |
| 15 | 6 | Yes | Pass | Pass | 17 |
| 16 | 7 | Yes | Pass | Pass | 22 |
| 17 | 8 | Yes | Pass | Pass | 25 |
| 18 | 9 | Yes | Pass | Pass | 36 |
| Control | Control | Yes | Pass | Pass | 11 |

It will be appreciated that various of the above-discussed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for preparing reactive silane esters, comprising:
providing a carboxylic acid-containing starting material;
reacting said carboxylic acid-containing starting material with a base to form a salt; and
reacting said salt with a halo-alkylene-silane to form a reactive silane ester compound.

2. The method of claim 1, wherein the carboxylic acid-containing starting material is of the formula 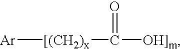
the halo-allylene-silane is of the formula Y-L-SiRₙ(OR)₃₋ₙ, and the reactive silane ester compound is of the formula 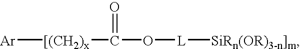
wherein:
Ar represents an aromatic group;
Y represents a halogen atom selected from the group consisting of I, Br, Cl and F;
L represents a divalent linking group;
each R independently represents a hydrogen atom, an alkyl group, or an aryl group;
n is an integer of from 0 to 2;
x is an integer of from 0 to 25; and
m is an integer of from 1 to 5.

3. The method of claim 2, wherein the carboxylic acid-containing starting material is an arylamine of the formula: 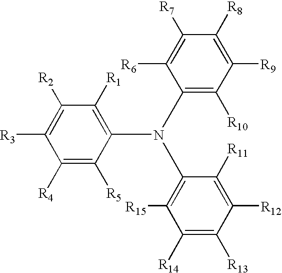
wherein R¹-R¹⁵, which can be the same or different, are selected from the group consisting of hydrogen, a halogen, an alkyl group, an aryl group optionally substituted by one or more alkyl groups, an alkyl group containing a heteroatom, and an aryl group containing a heteroatom and optionally substituted by one or more alkyl groups, provided that at least one of R¹-R¹⁵ is substituted by at least one carboxylic acid group or an alkyl group with a carboxylic group attached.

4. The method of claim 3, wherein the arylamine is a diphenylamine derivative.

5. The method of claim 3, wherein the arylamine is a disubstituted 4-aminobiphenyl compound.

6. The method of claim 2, wherein L is a divalent hydrocarbon group selected from the group consisting of —CₘH₂ₘ—, —CₘH₂ₘ₋₂—, —CₘH₂ₘ₋₄—, in which in is an integer of 1 to about 15, and combinations thereof, and wherein L may optionally have one or more substituent groups selected from the group consisting of alkyl groups, phenyl groups, alkoxyl groups and amino groups.

7. The method of claim 2, wherein each R is independently selected from the group consisting of hydrogen atoms, methyl groups, ethyl groups, propyl groups, butyl groups, and pentyl groups, and isomers thereof.

8. The method of claim 2, wherein said halo-alkylene-silane is selected from the group consisting of fluoropropylmethyldiisopropoxysilane, chloropropylmethyldiisopropoxysilane, bromopropylmethyldiisopropoxysilane and iodopropylmethyldiisopropoxysilane, and mixtures thereof.

9. The method of claim 1, wherein the carboxylic acid-containing starting material is of the formula: 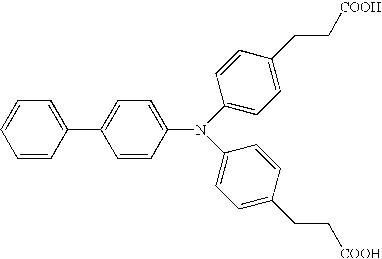
and the reactive silane ester compound is of the formula:

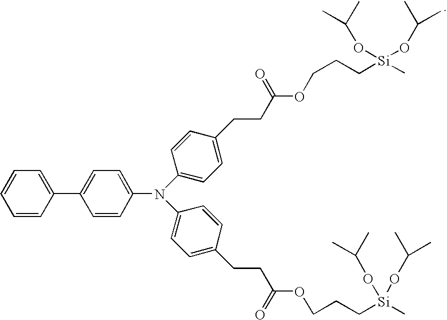

10. The method of claim 9, wherein the salt is potassium t-butoxide, the halo-alkylene-silane is a dialkyloxy silane that includes a halogenated alkyl group, and the method is carried out in a solvent system comprising a DMF-isopropanol mixture.

11. The method of claim 1, wherein said base has a general formula MOR, in which O is oxygen, M is a metal atom selected from the group consisting of potassium, sodium, lithium, calcium and magnesium, and R is a hydrogen or a straight or branched alkyl group selected from the group consisting of methyl, ethyl, propyl, butyl, pentyl, hexyl, heptyl, octyl, nonyl, and decyl groups.

12. The method of claim 11, wherein said base is potassium tert-butoxide.

13. The method of claim 11, wherein said base is a solid base.

14. The method of claim 1, wherein said carboxylic acid-containing starting material and said base are reacted in substantially equivalent amounts based on a number of carboxylic acid groups present in the starting material.

15. The method of claim 1, wherein said reacting said carboxylic acid-containing starting material with said base to form said aromatic salt is conducted in the presence of a first solvent.

16. The method of claim 15, wherein said first solvent is one or more solvents selected from alcohols, dimethylformamide, and mixtures thereof.

17. The method of claim 15, wherein said first solvent is a solvent system comprising isopropanol and dimethylformamide.

18. The method of claim 1, wherein said reacting said carboxylic acid-containing starting material with said base to form said salt is conducted at a temperature of from about 0° C. to about 1100° C.

19. The method of claim 18, wherein said reacting said carboxylic acid-containing starting material with said base to form said aromatic salt is conducted at a temperature of from about 50° C. to about 75° C.

20. The method of claim 1, wherein said reacting said salt with said halo-alkylene-silane to form said reactive silane ester compound is conducted in the presence of a second solvent.

21. The method of claim 20, wherein said second solvent is one or more solvents selected from the group consisting of alcohols, polar aprotic solvents, and mixtures thereof.

22. The method of claim 20, wherein said second solvent is one or more solvents selected from the group consisting of methanol, ethanol, isopropanol, butanol, dimethyl form amide, dimethylsulfoxide, acetone, ethyl acetate, tetrahydrofuran, methyl ethyl ketone, and mixtures thereof.

23. The method of claim 1, wherein said reacting said salt with said halo-alkylene-silane to form said reactive silane ester compound is conducted at a temperature of from about 25° C. to about 200° C.

24. The method of claim 23, wherein said reacting said salt with said halo-alkylene-silane to form said reactive silane ester compound is conducted at a temperature of from about 5° C. to about 30° C. greater than a temperature at which the salt is formed.

25. The method of claim 23, wherein said reacting said carboxylic acid-containing starting material with said base and said reacting said salt with said halo-alkylene-silane are conducted in the same reactor vessel, without purification of said salt.

26. The method of claim 1, further comprising purifying said salt before said reacting said salt with said halo-alkylene-silane.

27. The method of claim 1, further comprising purifying said reactive silane ester compound.

28. The method of claim 27, wherein said purifying comprises:
extracting said reactive silane ester compound using a solvent to form a crude extract; and
directly applying the crude extract into a silica gel chromatography column.

29. The method of claim 28, wherein a proportion of crude extract to silica gel in the column is from 1:30 to about 1:3.

30. The method of claim 28, wherein a proportion of crude extract to silica gel in the column is from 1:15 to about 1:7.
